(19) United States
(12) Patent Application Publication
(10) Pub. No.: US 2024/0147207 A1
(43) Pub. Date: May 2, 2024

(54) METHOD AND APPARATUS FOR DISASTER ROAMING IN A MOBILE COMMUNICATION SYSTEM

(71) Applicant: Samsung Electronics Co., Ltd., Gyeonggi-do (KR)

(72) Inventors: Mahmoud WATFA, Middlesex (GB); Lalith KUMAR, Bangalore (IN); Kailash Kumar JHA, Bangalore (IN); Samiran BHOWMIK, Bangalore (IN); Aman AGARWAL, Bangalore (IN)

(21) Appl. No.: 18/548,016

(22) PCT Filed: Mar. 2, 2022
(86) PCT No.: PCT/KR2022/002937

§ 371 Date: Aug. 25, 2023

(30) Foreign Application Priority Data
Mar. 1, 2021 (IN) 202131008494
Feb. 28, 2022 (GB) 2202701.5

(51) Int. Cl. H04W 4/90; H04L 9/32; H04W 8/02; H04W 12/03; H04W 48/02; H04W 48/18

(52) U.S. Cl. CPC H04W 4/90; H04L 9/3242; H04W 8/02; H04W 12/03; H04W 48/02; H04W 48/18

(57) ABSTRACT

The disclosure relates to a 5G or 6G communication system for supporting a higher data transmission rate. A method performed by a user equipment (UE) in a communication system is provided. The method includes receiving disaster configuration information being encrypted; decrypting the disaster configuration information to verify an integrity of the disaster configuration information before acting upon or storing the disaster configuration information; and identifying whether a disaster roaming is available based on the disaster configuration information.

### TECHNICAL FIELD

The present invention relates to improved means and methods to control when and how User Equipments, UEs, can make use of a Disaster Roaming, DR, service during Disaster Conditions, DC. A DC occurs when a network is adversely affected by e.g. a fire, earthquake etc. resulting in a loss of service to at least a part of the network. Under such a DC, a UE can temporarily make use of the services of another network on which it is referred to as a Disaster Roamer, to distinguish from the usual form of roaming when a UE is able to register with, usually, an overseas network, different to its registered home network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

In general, in the prior art, there is a lack of a method to control when UEs can use disaster roaming service based on their delay tolerance. More particularly, when a disaster condition occurs, the UEs that detect the disaster may attempt to use roaming services of another PLMN as required by the MINT (Minimization of Service Interruption) feature.

However, some devices may be delay tolerant e.g. meters in vending machines, temperature readers that emit readings every 12 hrs, etc. Such UEs may, in fact, be controlled with respect to whether they can use disaster roaming service e.g. by having a subscription indication in the Unified Data Management, UDM, function based on whether the serving PLMN (or AMF) may inform the UEs whether they can use disaster roaming service. However, just indicating whether or not they can use roaming service is not a complete solution since the disaster condition may last for a long time or a short time. Moreover, each device may be different with respect to the delay that it can tolerate. As such, an additional mechanism is desirable to control when such devices can actually use the disaster roaming service.

A further problem is experienced in the prior art. Namely, it is desirable to ensure that any instructions concerning a UE making use of Disaster Roaming are properly directed and protected from interference. If a UE were instructed to roam onto a third-party network by a malicious party, it might allow that party to take control of the UE in an unauthorised manner. Further, unwanted or unauthorised roaming charges can occur when a rogue entity falsely inform or instructs a UE to use disaster roaming, when the HPLMN does not want the UE to use disaster roaming.

### Solution to Problem

In accordance with an embodiment, a method performed by a user equipment (UE) in a communication system is provided. The method includes receiving disaster configuration information being encrypted; decrypting the disaster configuration information to verify an integrity of the disaster configuration information before acting upon or storing the disaster configuration information; and identifying whether a disaster roaming is available based on the disaster configuration information.

In accordance with an embodiment, a method performed by a core network entity in a communication system is provided. The method includes obtaining subscription information of a UE; identifying disaster configuration information being encrypted, based on the subscription information; and transmitting the disaster configuration information being encrypted. The disaster configuration information is used to identify whether a disaster roaming is available to the after a decryption of the disaster configuration information.

In accordance with an embodiment, a UE in a communication system is provided. The UE includes a transceiver and at least one processor. The at least one processor is configured to receive, via the transceiver, disaster configuration information being encrypted, decrypt the disaster configuration information to verify an integrity of the disaster configuration information before acting upon or storing the disaster configuration information, and identify whether a disaster roaming is available based on the disaster configuration information.

In accordance with an embodiment, a core network entity in a communication system, the core network entity includes a transceiver and at least one processor. The at least one processor is configured to: obtain subscription information of a UE, identify disaster configuration information being encrypted, based on the subscription information, and transmit, via the transceiver, the disaster configuration information being encrypted. The disaster configuration information is used to identify whether a disaster roaming is available to the after a decryption of the disaster configuration information.

### Advantageous Effects of Invention

Broadly, embodiments of the invention improve the security related to the exchange of information related to the use of Disaster Roaming. This ensures that a UE which is instructed to make use of, or authorised to use, DR can be confident that the instructions are legitimate and issued by a trusted entity i.e. its home network HPLMN.

Further, embodiments of the invention provide a means for the UE to verify that the information from the home network is legitimate and, if so, the UE uses the information. If the information is not legitimate, then the information is discarded and no action is taken in connection with it, in terms of DR.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 illustrates a deployment of RAN and non-3GPP Access Points with Connection to an AMF within a PLMN, known in the prior art;

FIG. 2 illustrates an example of a DC Area that covers a rectangular geographic area, known in the prior art;

FIG. 3 illustrates a message flow according to an embodiment of the invention;

FIG. 4 illustrates a message flow according to an embodiment of the invention;

FIG. 5 illustrates a message flow for performing the integrity check according to an embodiment of the invention;

FIG. 6 illustrates an electronic device according to embodiments of the present disclosure; and

FIG. 7 illustrates a core network entity according to embodiments of the present disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

Current specifications for telecommunication networks (e.g. 3GPP TS22.261) describe some requirements to avoid service interruptions that may arise when a disaster condition e.g. fire, occurs on a given Public Land Mobile Network, PLMN, and for which the UEs are to be redirected to another PLMN in a manner that keeps the service interruption to a minimum. The description of this can be found in 3GPP TS22.261:

“A mobile network may fail to provide service in the event of a disaster (for example a fire.) The requirements listed in this clause provide the Fifth Generation System, 5GS, with the capability to mitigate interruption of service. UEs may obtain service in the event of a disaster, if there are PLMN operators prepared to offer service. The minimization of service interruption is constrained to a particular time and place. To reduce the impact to the 5G System of supporting Disaster Roaming, the potential congestion resulting from an influx or outflux of Disaster Inbound Roamers is taken into account.”

As can be seen from the above, the service interruption is limited to a particular time and place and hence only the UEs that are in the given location at the given time of disaster will be impacted by the disaster condition and hence should be serviced by another PLMN.

The following detailed requirements are also listed in 3GPP TS22.261:

### 6.31.2 Requirements

### 6.31.2.1 General

Subject to regulatory requirements or operator's policy, 3GPP system shall be able to enable a UE of a given PLMN to obtain connectivity service (e.g. voice call, mobile data service) from another PLMN for the area where a Disaster Condition applies.

### 6.31.2.2 Disaster Condition

The 3GPP system shall enable UEs to obtain information that a Disaster Condition applies to a particular PLMN or PLMNs.

NOTE: If a UE has no coverage of its HPLMN, then obtains information that a Disaster Condition applies to the UE's HPLMN, the UE can register with a PLMN offering Disaster Roaming service.

The 3GPP system shall support means for a PLMN operator to be aware of the area where Disaster Condition applies.

The 3GPP system shall be able to support provision of service to Disaster Inbound Roamer only within the specific region where Disaster Condition applies.

The 3GPP system shall be able to provide efficient means for a network to inform Disaster Inbound roamers that a Disaster Condition is no longer applicable.

Subject to regulatory requirements or operator's policy, the 3GPP system shall support a PLMN operator to be made aware of the failure or recovery of other PLMN(s) in the same country when the Disaster Condition is applies, or when the Disaster Condition is not applicable.

### 6.31.2.3 Disaster Roaming

The 3GPP system shall be able to provide means to enable a UE to access PLMNs in a forbidden PLMN list if a Disaster condition applies and no other PLMN is available except for PLMNs in the forbidden PLMN list.

The 3GPP system shall provide means to enable that a Disaster Condition applies to UEs of a specific PLMN.

The 3GPP system shall be able to provide a resource efficient means for a PLMN to indicate to potential Disaster Inbound Roamers whether they can access the PLMN or not.

Disaster Inbound Roamers shall perform network reselection when a Disaster Condition has ended.

The 3GPP system shall minimize congestion caused by Disaster Roaming. 3GPP system shall be able to collect charging information for a Disaster Inbound Roamer with information about the applied disaster condition.

TR 24.811 is the specification that is used to perform the study based on these requirements. The TR in TR 24.811 captures key issues for which solutions will be developed and chosen for normative work when the study concludes.

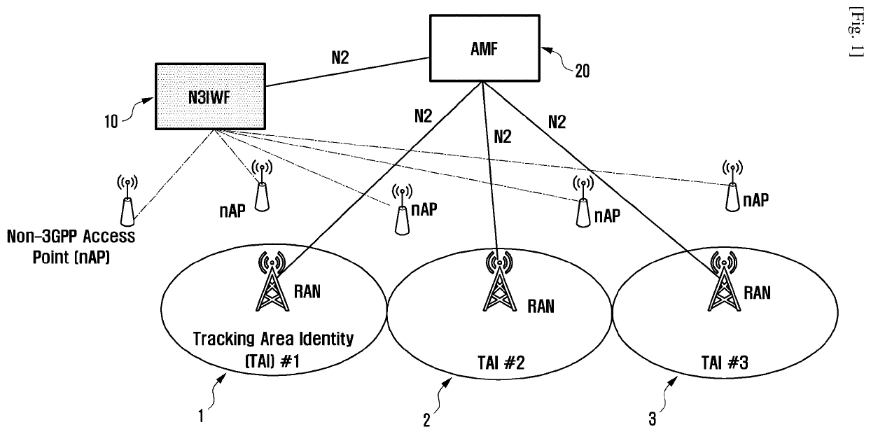

It is assumed that a disaster condition, DC, can occur on the Radio Access Network, RAN, level for which e.g. the radio towers will be non-functional and hence the UE cannot connect to the PLMN in the area where the DC occurred. For example, consider FIG. 1 which shows examples of RAN nodes 1, 2, 3 that connect to the Access and Mobility Management Function, AMF 20, of the PLMN.

Normally, every cell (or RAN node, which may support multiple cells) broadcasts the Tracking Area Identity (TAI), or actually a Tracking Area Code (TAC) in addition to the PLMN identity together which form the TAI of the cell. The UE identifies the PLMN ID (or TAI) of a cell based on this information that is broadcast.

Note that PLMN ID=Mobile Country Code (MCC)+Mobile Network Code (MNC) and TAI=PLMN ID+Tracking Area Code (TAC)=MCC+MNC+TAC.

A UE that registers to the 5GS will be provided with a registration area (RA), which consists of a set of TAIs (i.e. one or more TAI) in which the UE is allowed to enter without performing a registration procedure except for periodic updating or other reasons. For example, if the UE registers and receives an RA that is composed of TAI#1 and TAI #2, then the UE can move from TAI #1 to TAI #2 in idle mode without sending a Registration Request. On the other hand, if the UE enters a new area that is not part of the UE's RA e.g. TAI #3, then the UE is required to perform a registration procedure in order to get services during which the network will provide a new RA assuming the UE is indeed allowed to use the service in TAI #3.

When a DC occurs, the RAN nodes may be down and, as such, the UE may not receive any broadcast information and as such may not be able to receive any system information that would otherwise enable the UE to determine the PLMN ID or the TAI of the cell. In fact, the UE would not even detect a cell when this occurs.

Note that this assumes that the DC impacts the RAN such that no information can be sent by the RAN and, as such, the UE cannot detect the presence of the cell using normal methods.

As indicated earlier, a DC may be limited to a certain place and time. It is possible that the DC impacts one or more TAIs such as: the area covered by TAI #1 only, or TAI #2 only, or TAI #3 only; or the area covered by one or more TAIs e.g. TAI #1 and TAI #2 only, or TAI #2 and TAI #3 only, or TAI #1 and TAI #2 and TAI #3.

Note that the above is just an example to illustrate the location where a DC may occur. Additionally, a TAI, or a set of TAI, may also correspond to a particular geographic area that can be e.g. a set of geographical coordinates, where this set may for example define a particular shape such as a triangle, rectangle, or any other polygon, etc.

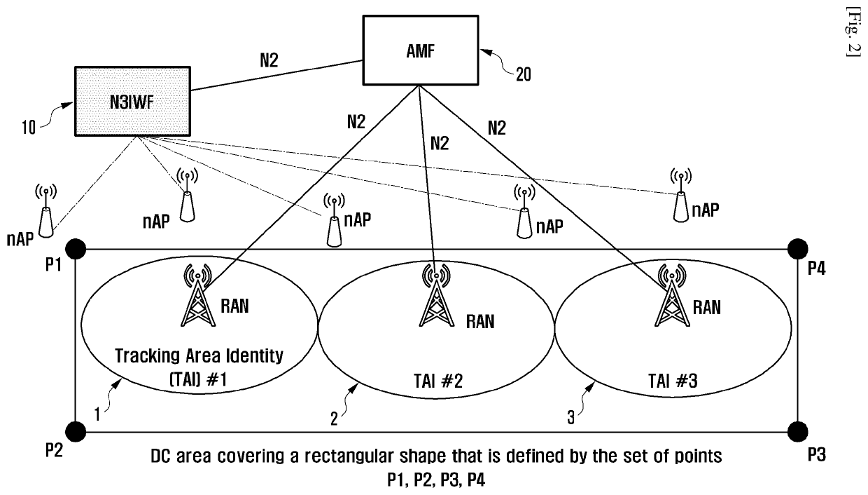

For example, the DC may span all the TAIs shown in FIG. 2 such that the DC may be composed of a set of 4 coordinate points (P1, P2, P3, P4) that define a rectangular shape that covers the cells that broadcast TAI #1 to TAI #3, associated with RANs 1, 2, 3 respectively.

When a DC occurs, and the UE is aware of it, the UE will attempt to register on another PLMN, where this PLMN may be a visited PLMN (VPLMN) i.e. the PLMN may not be the UE's home PLMN (HPLMN). In fact, the UE may be allowed to use a PLMN in the list of forbidden PLMNs that the UE maintains.

When the UE registers on another PLMN where there is no DC, the UE can receive services from that PLMN, e.g. a target VPLMN, until the DC in its source PLMN (e.g. HPLMN or a previous source VPLMN) ends. The UE can then return to the previous PLMN.

As the number of UEs that go to a target PLMN due to a DC, or return to source PLMN after a DC ends, the requirements listed earlier require that this be done in a way that avoids congestion on a (target or source) PLMN that may result from a very large number of UEs attempting registration at the same time.

In general, in the prior art, there is a lack of a method to control when UEs can use disaster roaming service based on their delay tolerance. More particularly, when a disaster condition occurs, the UEs that detect the disaster may attempt to use roaming services of another PLMN as required by the MINT (Minimization of Service Interruption) feature.

However, some devices may be delay tolerant e.g. meters in vending machines, temperature readers that emit readings every 12 hrs, etc. Such UEs may, in fact, be controlled with respect to whether they can use disaster roaming service e.g. by having a subscription indication in the Unified Data Management, UDM, function based on whether the serving PLMN (or AMF) may inform the UEs whether they can use disaster roaming service. However, just indicating whether or not they can use roaming service is not a complete solution since the disaster condition may last for a long time or a short time. Moreover, each device may be different with respect to the delay that it can tolerate. As such, an additional mechanism is desirable to control when such devices can actually use the disaster roaming service.

A further problem is experienced in the prior art. Namely, it is desirable to ensure that any instructions concerning a UE making use of Disaster Roaming are properly directed and protected from interference. If a UE were instructed to roam onto a third-party network by a malicious party, it might allow that party to take control of the UE in an unauthorised manner. Further, unwanted or unauthorised roaming charges can occur when a rogue entity falsely inform or instructs a UE to use disaster roaming, when the HPLMN does not want the UE to use disaster roaming.

It is an aim of an embodiment of the present invention to address issues in the prior art whether mentioned herein or not.

According to the present invention there is provided an apparatus and method as set forth in the appended claims. Other features of the invention will be apparent from the dependent claims, and the description which follows.

According to a first aspect of the present invention, there is provided a method of a telecommunication network managing Disaster Roaming, DR, of a User Equipment in communication with the telecommunication network, comprising the step of the telecommunication network transmitting to the UE, Disaster Configuration Information, DCI, in an encrypted manner, such that the UE is then able to decrypt the DCI to verify its integrity before acting upon or storing the DCI.

According to a second aspect of the present invention, there is provided a method of a User Equipment, UE, managing Disaster Roaming, DR, wherein the UE receives Disaster Configuration Information, DCI, in an encrypted manner from a telecommunication network, wherein the UE decrypts the DCI to verify its integrity before acting upon or storing the DCI.

In an embodiment, the UE upon receiving the encrypted DCI, decrypts the encrypted DCI and verifies its authenticity on the basis of a key provided by the UE's home network, HPLMN.

In an embodiment, the UE, upon successful verification of the integrity of the DCI, acts upon or stores the information included therein.

In an embodiment, if the UE is unable to verify the integrity of the DCI, the DCI is discarded and no action is taken in relation thereto.

In an embodiment, the DCI comprises information related to whether the UE is able to use a target PLMN for DR.

In an embodiment, the DCI further comprises information related to one or more condition related to the UE's use of Disaster Roaming.

In an embodiment, the one or more condition related to the UE's use of Disaster Roaming comprises one or more of:
the UE's delay tolerance, expressed in a descriptive or numerical manner;
one or more locations, or a defined region, where the UE may use DR;
a time of day when the UE may use DR;
a defined duration for which the UE may use DR;
an amount of data that the UE is permitted to send while DR; and
one or more features to be requested while using disaster roaming service.

According to a third aspect of the present invention, there is provided telecommunication network arranged to manage the use of DR of a User Equipment, UE, in communication with the telecommunication network, wherein the telecommunication network is arranged to transmit to the UE, Disaster Configuration Information, DCI, in an encrypted manner, such that the UE is then able to decrypt the DCI to verify its integrity before acting upon or storing the DCI.

According to a fourth aspect of the present invention, there is provided UE, arranged to receive, from a telecommunication network, Disaster Configuration Information, DCI, in an encrypted manner, the UE being further arranged to verify its integrity before acting upon or storing the DCI.

Broadly, embodiments of the invention improve the security related to the exchange of information related to the use of Disaster Roaming. This ensures that a UE which is instructed to make use of, or authorised to use, DR can be confident that the instructions are legitimate and issued by a trusted entity i.e. its home network HPLMN.

Further, embodiments of the invention provide a means for the UE to verify that the information from the home network is legitimate and, if so, the UE uses the information. If the information is not legitimate, then the information is discarded and no action is taken in connection with it, in terms of DR.

The following section proposes solutions to the identified problem above. Note that the proposals herein may be used in conjunction with an indication regarding whether the UE should be allowed to use a different PLMN that offers service (e.g. disaster roaming service) after a disaster occurs in the UE's source PLMN. As such, all the proposals herein may be used, or may be assumed to be used in conjunction with such an indication (e.g. an indication that the UE is not allowed to use disaster roaming service).

Although a few preferred embodiments of the present invention have been shown and described, it will be appreciated by those skilled in the art that various changes and modifications might be made without departing from the scope of the invention, as defined in the appended claims.

Embodiments of the present invention provide a solution to the identified problem above. Note that the description provided herein may be used in conjunction with an indication regarding whether the UE should be allowed to use a different PLMN that offers service (e.g. disaster roaming service) after a disaster occurs in the UE's source PLMN. As such, all the details herein may be used, or may be assumed to be used, in conjunction with such an indication (e.g. an indication that the UE is not allowed to use disaster roaming service).

Different UEs may have different tolerance for delays with respect to communication. For example, some devices may read a temperature and report it every 2 hrs, whereas other may send a similar or different report every 10 hrs, etc. Such UEs may be considered as a separate type of UE to the more familiar mobile telephone, smartphone, table etc. which is typically carried by a person.

A new set of parameters is defined in the subscription information that describes or contains the delay tolerance of the UE and/or other information as will be set out below. For example, the set of parameters may include a tolerance which may be a descriptive tolerance, for example, “low delay tolerance”, “medium delay tolerance”, or “high delay tolerance”, etc. noting that these are to be considered as examples only. The descriptive tolerance indication or parameter may also be associated with, or may take the form of, a time value indicating how long a device can tolerate not being served by a network during a disaster (and hence optionally indication how long the UE needs to wait before attempting to get service on a disaster roaming PLMN if needed).

The UDM provides this information to a serving AMF, where the serving AMF may be in the HPLMN or a VPLMN where the UE is currently being served, or where the UE is registering, or where the UE is registered.

During the registration procedure, the UDM, e.g. when the AMF of the serving PLMN attempts to fetch the UE's subscription information, provides this descriptive tolerance parameter to the AMF.

It should be noted that the descriptive tolerance may be as described above e.g. an indication of the tolerance level of the UE (e.g. “low delay tolerance”, “medium delay tolerance”, or “high delay tolerance”) and/or a timer describing the time that the UE can tolerate before using a disaster roaming service, or any other indication about a UE's tolerance with respect to receiving service in a disaster roaming area. For example, the information may also include any of the following items of information, alone or in combination:
Location information describing where the UE may be allowed, or may not be allowed, to get disaster roaming service. For example, the location information may indicate that if the UE is in a certain area or location, then the UE is not allowed to use disaster roaming service when a disaster occurs in that area. Further, the location information may indicate that if the UE is in a certain area or location, then the UE is allowed to use disaster roaming service when a disaster occurs in that area. Note that the area may be defined using any technique that can identify a geographical area such as, but not limited to, a set of coordinates, etc.
A time, where the time may indicate a time, or time period, at or during which the UE is allowed to receive disaster roaming service, or during which the UE is not allowed to receive disaster roaming service. For example, a time period, between 15:00 hr to 19:00 hr, during which the UE is not allowed to receive disaster roaming service, because it is a time period that is considered to be busy. For example, a time period between 22:00 hr to 24:00 hr, during which the UE is allowed to receive disaster roaming service, because it is a time period that is considered not to be busy.
A time duration defining the duration of time that the UE can receive service after registering in a disaster roaming PLMN. For example, the time may be 30 min, which means that the UE may only register on a disaster roaming service and use the service of the PLMN for a duration of 30 min. After this duration, the UE may be required to deregister and wait again for another period of time to elapse before attempting to register again if the disaster condition is detected to be persistent or existent. The UE, as such, may, after registering and using the service for the indicated time, wait for a certain period of time to elapse where this period of time may be as defined above by the descriptive tolerance parameter.
One or more parameters or descriptions that describe how much data the UE can send while it is using the disaster roaming service. This parameter may be in the form of any of the following: a total amount of data that can be sent by the UE e.g. M bytes, where M is an integer or real number; a rate of data that can be sent by the UE, e.g. N bits per time, where N can be a real number or integer and ‘time’ can be in seconds, hours, minutes, etc.
One or more features that should be requested while using disaster roaming service, for example, the UE may be requested to use any of the following in any combination: Mobile Initiated Connection Only, MICO, mode; Extended Discontinuous Reception, DRX; a particular Cellular Internet of Things, CIoT, optimization feature e.g. control plane CIoT 5GS optimization, user plane CIoT 5GS optimization; or any other feature to be defined.

The UDM provides any one or more of the above to the serving AMF. When the serving AMF receives any one or more of the above parameters, the serving AMF may make further determinations on these one or more parameters based on local policies. For example, the AMF may determine that “high delay tolerance” translates to a certain time delay e.g. 8 hrs. The actual value may be set locally as required.

Note that this information may be updated at the UDM. When this occurs, the UDM should in turn update the AMF accordingly. The AMF should then update its stored information (i.e. any of the information listed above) accordingly and optionally update any other parameters that may have been determined as set out above.

When the UE registers with the serving AMF, where the serving AMF may be in a serving PLMN, where the serving PLMN may be an HPLMN or a VPLMN, the serving AMF should provide the UE with any subset of the parameters listed above. The AMF may provide this information to the UE using any NAS message such as Registration Accept message, Configuration Update Command message, etc.

For example, the AMF may provide the UE with a delay tolerance description, where this may represent a time period during which the UE shall not use a disaster roaming service. For example, this time represents the time that the UE is expected to be tolerant to the lack of a service after the UE detects a disaster condition. For example, the UE, after detection or determination that a disaster condition has occurred on a PLMN, where the PLMN may be a PLMN that the UE is/was registered in, the UE can start a timer and set its value to the value received from the AMF. Note that if the UE had received a descriptive tolerance such as “high tolerance” etc., then the UE may start a timer with a value that corresponds to this descriptive tolerance. The value associated with this descriptive tolerance may be pre-configured in the UE, or may have been provided to the UE by the network e.g. by the AMF using any NAS message. Optionally, the timer is only started if the UE receives an indication that the UE is allowed to use disaster roaming service in a target PLMN. Note that the UE can also start the timer even if the indication it had received indicates that disaster roaming service is not allowed as described herein.

As such, the UE starts the timer when it detects a disaster condition. The UE does not use disaster roaming service during this time, except if certain exceptional conditions occur, where these exceptional conditions will be explained shortly.

Upon expiry of the timer, the UE may use a disaster roaming service from a different PLMN if needed. For example, the UE may attempt to register to a PLMN that offers disaster roaming when the UE needs to send data. It should be noted that the UE may not need to send data, but if this is the case, then the UE can do so after this timer expires.

During the lifetime of this timer, i.e. before the UE registers on a PLMN offering disaster roaming, the UE may optionally disable its lower layer capabilities e.g. NR access/capability or E-UTRA access/capability to save power. The UE may enable this access/capability when the timer expires or just before it expires, or after it expires but when there becomes a need to send data, in order to perform PLMN selection and/or to select a PLMN that offers disaster roaming.

During the lifetime of this timer, or during the lifetime of any such timer that may have been provided to a UE (where the timer may represent e.g. a “wait timer” that is used to stagger the arrival/registration of the UE to a PLMN offering disaster roaming service), if the UE detects that its previous PLMN is available (e.g. the UE detects that the disaster condition no longer exists and optionally before the UE has registered to a different/new PLMN to get disaster roaming service), the UE should stop the timer and may perform a registration with its previous PLMN, optionally if the UE's periodic timer has not yet expired for the previous PLMN. Alternatively, the UE stops any “wait timer” or timer as set out herein when the UE successfully registers (or attempts to register) with a PLMN, optionally where the PLMN is the UE's previous (selected or registered) PLMN (HPLMN or VPLMN) that no longer has a disaster condition.

When the UE registers with a new/different PLMN to get disaster roaming service, if the UE has received any other information as listed above, then the UE should enforce them in the target PLMN. For example, the UE may:
Use a disaster roaming service for a certain period of time only, where this time may be known to the UE from a previous registration or may be provided to (or received by) the UE from the network (e.g. AMF) that is provided disaster roaming service. As such, the UE may optionally start a timer representing this time during which service should be received, where the timer may be started after the UE successfully registers with the target network/PLMN (where disaster roaming service is being received). Upon expiry of the timer, the UE may perform a deregistration or locally enter a deregistered state for this PLMN. At this point, the UE may start a timer again to represent a period of time during which the UE should wait again, etc.
Send data according to a certain limit as set out earlier, where this limit (or rate, etc.) where this limit may be known to the UE from a previous registration or may be provided to (or received by) the UE from the network (e.g. AMF) that is providing the disaster roaming service. The UE may also perform a deregistration or locally enter a deregistered state for this PLMN after reaching the determined limit. At this point, the UE may start a timer again to represent a period of time during which the UE should wait again, etc. Alternatively, the UE may remain registered and e.g. perform periodic registration but not send data until a certain time elapses, etc.
The UE may only register and/or send data if the current time is a time known to be permitted for the UE to register and/or send data according to a known time window that represents e.g. when the UE is allowed to register and/or use the service as explained above.
The UE may request to use specific features e.g. MICO, specific CIoT optimizations, etc., as per the information that the UE may have received from a previous registration. These features may be requested in any NAS message such as the Registration Request.
The UE may determine to use a disaster roaming service if e.g. it is within an area describing a location where disaster roaming service is permitted. The UE may determine its position relative to the received location area using methods such as, but not limited to, GPS, etc.
Note that the above is just an example. However, the UE is expected to make a determination of whether it can use disaster roaming based on information received from the network, where the network may be a previous network (HPLMN or VPLMN) or a PLMN that is offering disaster roaming service. When certain conditions are met e.g. with regards to time, location, delay, etc., then the UE may use disaster roaming service or may attempt to register on a PLMN offering disaster roaming service. Otherwise, if certain conditions are not met, the UE may refrain from using disaster roaming service on a PLMN except if other exceptional conditions occur as will be set out later.
Note that the UE may enforce any of the above by monitoring its activities and/or how much data is being sent on the user plane and/or control plane, etc.

Note that any combination of the information that is listed earlier may also be provided to the UE by the PLMN that is offering disaster roaming service. For example, the UDM may provide any of the information listed earlier to the AMF/network of the PLMN that is providing the disaster roaming service during the registration of the UE and for which the network e.g. AMF, attempts to get the subscription information of the UE from the UDM. Based on the received information, the AMF may make further determinations as described earlier and in turn provide the UE with a set of information that indicates when a service/registration can be done, and/or what type of service can be used, and/or the rate and/or limit of data that can be sent, the location where the service can be used, etc.

The AMF may also enforce the service information or requirements that were received from the UDM. For example, the AMF may:
Accept or reject the UE's registration based on the location of the UE compared to a location information where the UE is allowed to use disaster roaming service. For example, the network accepts the registration if the UE is allowed to use disaster roaming service in a certain area, assuming a disaster condition has occurred in known area. For example, the network rejects the registration if the UE is not allowed to use disaster roaming service in a certain area, assuming a disaster condition has occurred in the known area,
Accept or reject the UE's registration based on the time of the day when the UE is requesting to use disaster roaming service (as described earlier regarding the time of the day in which the UE may or may not be allowed to use the service),
Provide to the UE and/or enforce a certain limit regarding how much data can be sent as described earlier,
May deregister the UE e.g. after the UE uses the disaster roaming service for a certain time, where this time may have been received from the UDM or based on local policies in the AMF, etc.

As explained earlier, when the UE is waiting for a time period (e.g. based on a delay tolerance of the UE as proposed herein), some exceptional conditions may occur that should trigger the UE to attempt and use disaster roaming service even when the timer is running. Note that attempting to use disaster roaming service may imply performing PLMN selection for disaster roaming service and/or registering to a selected PLMN for disaster roaming service and/or requesting a particular service from a PLMN such as a PDU session. The exceptional conditions may be:
A request (e.g. from upper layers) to place an emergency call,
A request (e.g. from upper layers) to send a particular type of data such as, but not limited to: Location information (e.g. for location service message, LPP, etc.); SMS; UE policy container, etc.,
Data related to exception reporting (or data for reporting an exceptional event) e.g. for the case when the UE is using a particular CIoT 5GS optimization e.g. the UE is in NB-IoT mode, etc.

When the UE determines to use disaster roaming service due to an exceptional event, the UE may stop the delay tolerance timer or may keep it running. The UE may deregister after using a service related to the exceptional condition and may wait again (e.g. based on a timer) before it uses disaster roaming service.

Note that for any of the parameters above e.g. descriptive tolerance, data rate limit, etc., a third party application function (AF) may interact with the HPLMN of the UE, or the serving PLMN of the UE, to modify or set these parameters accordingly. This may be done via a network exposure function (NEF) of the network, which may then forward the information to the UDM, optionally via the PCF (Policy Control Function) node.

When the UDM receives this information, optionally from the PCF or the NEF, or any other node, the UDM should update the stored information for a UE in question, where the UE may be identified by a unique identity (which may be e.g. a group identity). The UDM should then update the serving AMF with this new information. In turn, upon reception of an updated information from the UDM, where this information is related to any of the set of parameters described herein, the network or AMF should update the UE with this information.

Similarly, when the UE receives a new or updated information, where this information is any of the information or parameters herein, the UE stores the updated/new information (or replaces the old information with the new information) and uses this latest stored information as explained herein.

As set out earlier, this set of new parameters, listed herein, may optionally be used with any existing indication that may be provided to the UE, where this indication may be an indication informing the UE that disaster roaming is not, or is, permitted. For example, the UE may be informed that disaster roaming is not permitted and provided with the information set out herein. The UE considers that disaster roaming is not to be used until e.g. a certain time elapses, as described herein for example, based on a delay tolerance level or timer.

Information to control whether or not the UE can use a target PLMN for disaster roaming service is to be controlled and provided by the HPLMN of the UE e.g. by the UDM. The information is protected by a key in the HPLMN node (e.g. Authentication Server Function, AUSF) and this protected information is sent to the UE via the serving network e.g. VPLMN or HPLMN, or the AMF of VPLMN or HPLMN. The protection of the information can be done e.g. by integrity protection of the information and optionally including a MAC (Message Authentication Code) that may be identified by a MAC ID. This protected information may be sent in any NAS message or UE container that may also be included in any NAS message. Protection of this information is important, since the UE must be able to verify that any attempt to register away from its home network, even in a Disaster Condition, is authorised and legitimate. A rogue entity could attempt to lure a UE away from its home network in an attempt to take over the operation of the UE or to obtain information from it.

When the UE receives a security protected information, the UE verifies the integrity of the received information and verifies it against the MAC. If the integrity check fails, then the UE discards the information. Otherwise, if it passes, the UE processes the information and uses it to determine whether it can use the disaster roaming service, and when to do so etc. This determination relates to the basic information of whether the UE is authorised to make use of DR and also the conditions which may be attached thereto. All of this is considered as Disaster Configuration Information, DCI, as referred to previously.

Optionally, if the security check or integrity check on the protected received information fails, the UE may consider the current PLMN as a low priority PLMN and perform a PLMN search and/or selection.

Alternatively, this (optionally protected) information is optionally only provided to the UE when the UE registers with its HPLMN using any NAS message. Optionally in this case, assuming that this information is only to come from the HPLMN, the UE may ignore this information if received from a VPLMN.

The information can include any of the following:
Indication of whether the UE is allowed (or not allowed) to use disaster roaming in a target PLMN, optionally where the target PLMN may be a forbidden PLMN, optionally the indication may be different for a forbidden PLMN,
Any combination of the parameters that have been previously listed herein.

Note that embodiments of the invention provide for the sending of information to the UE, where this information helps to control whether or not the UE is allowed to use the disaster roaming service, and optionally when and how to use this service. The information provided to the UE can be given any title, where its contents can be any combination of the information, parameters, or indications that have been listed herein. For example, the information can be, as an example, referred to as Disaster Configuration Information, noting that this is just an example. The contents of this information may also be extended to include other parameters or indications or descriptions that help control how the UE can use disaster roaming service if permitted. The UE is expected to receive this information, optionally process it, store it and optionally act upon it based on its contents when optionally certain conditions are satisfied. The certain conditions include the security check referred to previously which is provided to ensure that the legitimacy of the information is confirmed before any action is taken in relation to it.

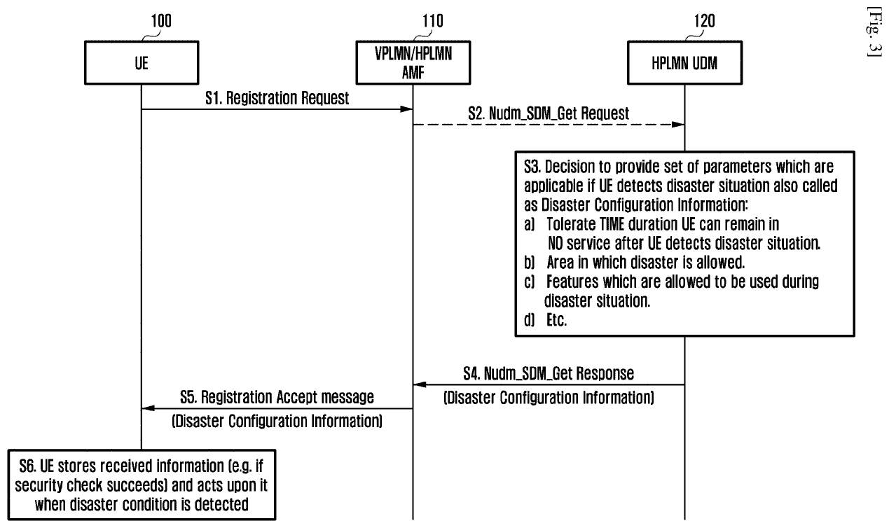

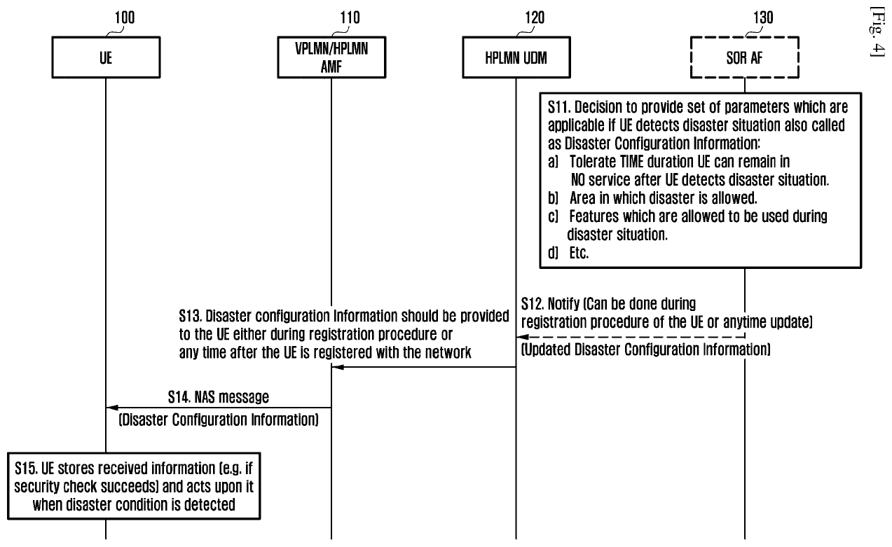

FIGS. 3 and 4 illustrate message flows associated with embodiments of the invention, as described previously.

FIG. 3 shows messages exchanged and processes, S1-S6, involving UE 100, the AMF 110 of the home or visited PLMN and the UDM 120 of the HPLMN.

At S1, the UE sends a registration request to AMF 110. At S2, this is forwarded to the UDM 120 of the home network. At S3, the UDM provides a set of parameters which form part of the DCI. At S4, the response is sent to the AMF 110. At S5 the registration accept message is sent from AMF 110 to UE 100. At S6, provided the integrity check is passed, then the UE 100 stores the DCI and acts upon it if/when a DC is detected.

FIG. 4 shows messages exchanged and processes, S11-S15, involving UE 100, the AMF 110 of the home or visited PLMN, the UDM 120 of the HPLMN and a Steering Of Roaming Application Function 130.

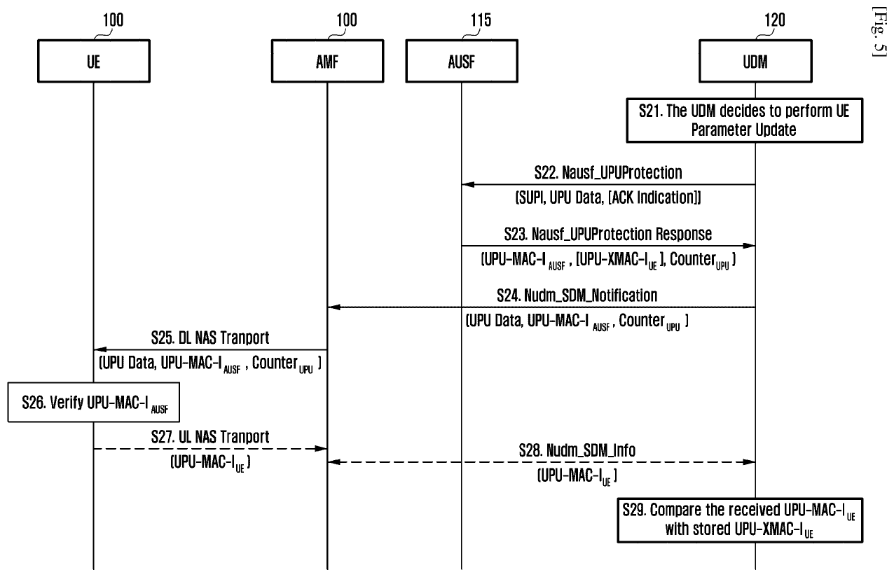

FIG. 5 is known from 3GPP TS 33.501 V16.3.0 and illustrates the procedure for UE parameters update, which is the means by which the integrity check referred to herein may be performed.

The UDM may decide to perform UE parameters update anytime after the UE has been successfully authenticated and registered to the 5G system. The security procedure for the UE parameters update is shown in FIG. 5. The following describes the steps/processes shown.

S21) The UDM 120 decides to perform the UE Parameters Update (UPU) using the control plane procedure while the UE 100 is registered to the 5G system. If the final consumer of any of the UE parameters to be updated (e.g., the updated Routing ID Data) is the USIM, the UDM shall protect these parameters using a secured packet mechanism (see 3GPP TS 31.115) to update the parameters stored on the USIM. The UDM shall then prepare the UE Parameters Update Data (UPU Data) by including the parameters protected by the secured packet, if any, as well as any UE parameters for which final consumer is the ME (see TS 24.501).

S22-S23) The UDM shall invoke Nausf_UPUProtection service operation message by including the UPU Data to the AUSF 115 to get UPU-MAC-IAUSF and CounterUPU as specified in sub-clause 14.1.4 of 3GPP TS 33.501. If the UDM decided that the UE is to acknowledge the successful security check of the received UE Parameters Update Data, then the UDM shall set the corresponding indication in the UE Parameters Update Data (see TS 24.501) and include the ACK Indication in the Nausf_UPUProtection service operation message to signal that it also needs the expected UPU-XMAC-IUE, as specified in sub-clause 14.1.4 of 3GPP TS 33.501. The details of the CounterUPU is specified in sub-clause 6.15.2.2 of 3GPP TS 33.501. The inclusion of UE Parameters Update Data in the calculation of UPU-MAC-IAUSF allows the UE to verify that it has not been tampered by any intermediary. The expected UPU-XMAC-IUE allows the UDM to verify that the UE received the UE Parameters Update Data correctly.

S24) The UDM shall invoke Nudm_SDM_Notification service operation, which contains UE Parameters Update Data, UPU-MAC-IAUSF, CounterUPU within the Access and Mobility Subscription data. If the UDM requests an acknowledgement, it shall temporarily store the expected UPU-XMAC-IUE.

S25) Upon receiving the Nudm_SDM_Notification message, the AMF 110 shall send a DL NAS Transport message to the served UE. The AMF shall include in the DL NAS Transport message the transparent container received from the UDM.

S26) On receiving the DL NAS Transport message, the UE shall calculate the UPU-MAC-IAUSF in the same way as the AUSF (as specified in Annex A.19 of 3GPP TS 33.501) on the received UE Parameters Update Data and the CounterUPU and verify whether it matches the UPU-MAC-IAUSF value received in the DL NAS Transport message. If the verification of UPU-MAC-IAUSF is successful and the UPU Data contains any parameters that is protected by secured packet (see 3GPP TS 31.115), the ME shall forward the secured packet to the USIM using procedures in 3GPP TS 31.111. If the verification of UPU-MAC-IAUSF is successful and the UPU Data contains any parameters that is not protected by secure packet, the ME shall update its stored parameters with the received parameters in UDM Updata Data.

S27) If the UDM has requested an acknowledgement from the UE and the UE has successfully verified and updated the UE Parameters Update Data provided by the UDM, then the UE shall send the UL NAS Transport message to the serving AMF. The UE shall generate the UPU-MAC-IUE as specified in Annex A.20 and include the generated UPU-MAC-IUE in a transparent container in the UL NAS Transport message.

S28) If a transparent container with the UPU-MAC-IUE was received in the UL NAS Transport message, the AMF shall send a Nudm_SDM_Info request message with the transparent container to the UDM.

S29) If the UDM indicated that the UE is to acknowledge the successful security check of the received UE Parameters Update Data, then the UDM shall compare the received UPU-MAC-IUE with the expected UPU-XMAC-IUE that the UDM stored temporarily in step S24.

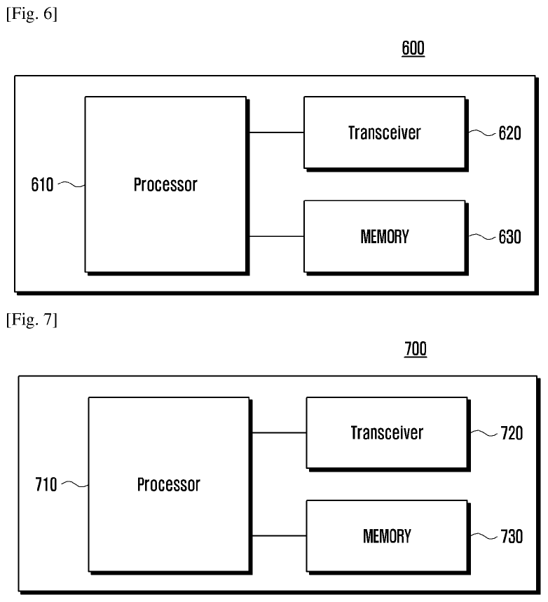

FIG. 6 illustrates an electronic device according to embodiments of the present disclosure.

Referring to the FIG. 6, the electronic device 600 may include a processor (or a controller) 610, a transceiver 620 and a memory 630. However, all of the illustrated components are not essential. The electronic device 600 may be implemented by more or less components than those illustrated in FIG. 6. In addition, the processor 610 and the transceiver 620 and the memory 630 may be implemented as a single chip according to another embodiment.

The electronic device 600 may correspond to electronic device described above. For example, the electronic device 600 may correspond to the terminal or the UE 100 illustrated in FIGS. 3-5.

The aforementioned components will now be described in detail.

The processor 610 may include one or more processors or other processing devices that control the proposed function, process, and/or method. Operation of the electronic device 600 may be implemented by the processor 610.

The transceiver 620 may include a RF transmitter for up-converting and amplifying a transmitted signal, and a RF receiver for down-converting a frequency of a received signal. However, according to another embodiment, the transceiver 620 may be implemented by more or less components than those illustrated in components.

The transceiver 620 may be connected to the processor 610 and transmit and/or receive a signal. The signal may include control information and data. In addition, the transceiver 620 may receive the signal through a wireless channel and output the signal to the processor 610. The transceiver 620 may transmit a signal output from the processor 610 through the wireless channel.

The memory 630 may store the control information or the data included in a signal obtained by the electronic device 600. The memory 630 may be connected to the processor 610 and store at least one instruction or a protocol or a parameter for the proposed function, process, and/or method. The memory 630 may include read-only memory (ROM) and/or random access memory (RAM) and/or hard disk and/or CD-ROM and/or DVD and/or other storage devices.

FIG. 7 illustrates a core network entity according to embodiments of the present disclosure.

Referring to the FIG. 7, the core network entity 700 may include a processor (or a controller) 710, a transceiver 720 and a memory 730. However, all of the illustrated components are not essential. The core network entity 700 may be implemented by more or less components than those illustrated in FIG. 7. In addition, the processor 710 and the transceiver 720 and the memory 730 may be implemented as a single chip according to another embodiment.

The core network entity 700 may correspond to the AMF, UDM, AF, or AUSF described above. For example, the core network entity 700 may correspond to the AMF 110 illustrated in FIGS. 3-5.

The aforementioned components will now be described in detail.

The processor 710 may include one or more processors or other processing devices that control the proposed function, process, and/or method. Operation of the core network entity 700 may be implemented by the processor 710.

The transceiver 720 may be connected to the processor 710 and transmit and/or receive a signal. The signal may include control information and data. In addition, the transceiver 720 may receive the signal and output the signal to the processor 710. The transceiver 720 may transmit a signal output from the processor 710.

The memory 730 may store the control information or the data included in a signal obtained by the core network entity 700. The memory 730 may be connected to the processor 710 and store at least one instruction or a protocol or a parameter for the proposed function, process, and/or method. The memory 730 may include read-only memory (ROM) and/or random access memory (RAM) and/or hard disk and/or CD-ROM and/or DVD and/or other storage devices.

Although this disclosure has been described with an exemplary embodiment, various changes and modifications may be suggested to one skilled in the art. It is intended that this disclosure encompass such changes and modifications as fall within the scope of the appended claims.

By virtue of an embodiment of the present invention, improved performance and better security is provided in the realm of disaster roaming.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-15. (canceled)

16. A method performed by a user equipment (UE) in a communication system, the method comprising:
receiving an indication of whether disaster roaming is enabled in the UE and a message authentication code for integrity (MAC-I) related to a UE parameters update (UPU);
performing a verification of the MAC-I related to the UPU; and
determining whether to use or discard the indication based on the verification.

17. The method of claim 16, wherein the indication is generated by a unified data management (UDM) entity related to a home public land mobile network (HPLMN) of the UE.

18. The method of claim 16, wherein the indication and the MAC-I related to the UPU are received via a non-access stratum (NAS) message.

19. The method of claim 16, further comprising, upon a disaster condition, in case that the indication indicates that the disaster roaming is enabled in the UE, performing the disaster roaming.

20. A method performed by a unified data management (UDM) entity in a communication system, the method comprising:
generating an indication of whether disaster roaming is enabled in a user equipment (UP;
obtaining, from an authentication server function (AUSF) entity, a message authentication code for integrity (MAC-I) related to a UE parameters update (UPU); and
transmitting the indication and the MAC-I related to the UPU,
wherein a verification of the MAC-I related to the UPU is associated with whether the indication is used or discarded in the UE.

21. The method of claim 20, wherein the UDM is related to a home public land mobile network (HPLMN) of the UE, and
wherein the indication and the MAC-I related to the UPU are transmitted to the UE via a non-access stratum (NAS) message.

22. The method of claim 20, wherein, upon a disaster condition, in case that the indication indicates that the disaster roaming is enabled in the UE, the disaster roaming is performed.

23. A user equipment (UE) in a communication system, the UE comprising:
a transceiver; and
a processor configured to:
receive, via the transceiver, an indication of whether disaster roaming is enabled in the UE and a message authentication code for integrity (MAC-I) related to a UE parameters update (UPU),
perform a verification of the MAC-I related to the UPU, and
determine whether to use or discard the indication based on the verification.

24. The UE of claim 23, wherein the indication is generated by a unified data management (UDM) entity related to a home public land mobile network (HPLMN) of the UE.

25. The UE of claim 23, wherein the indication and the MAC-I related to the UPU are received via a non-access stratum (NAS) message.

26. The UE of claim 23, wherein the processor is further configured to, upon a disaster condition, in case that the indication indicates that the disaster roaming is enabled in the UE, perform the disaster roaming.

27. A unified data management (UDM) entity in a communication system, the UDM entity comprising:
a transceiver; and
a processor configured to:
generate an indication of whether disaster roaming is enabled in a user equipment (UE),
obtain, from an authentication server function (AUSF) entity, a message authentication code for integrity (MAC-I) related to a UE parameters update (UPU), and
transmit, via the transceiver, the indication and the MAC-I related to the UPU,
wherein a verification of the MAC-I related to the UPU is associated with whether the indication is used or discarded in the UE.

28. The UDM entity of claim 27, wherein the UDM is related to a home public land mobile network (HPLMN) of the UE.

29. The UDM entity of claim 27, wherein the indication and the MAC-I related to the UPU are transmitted to the UE via a non-access stratum (NAS) message.

30. The UDM entity of claim 27, wherein, upon a disaster condition, in case that the indication indicates that the disaster roaming is enabled in the UE, the disaster roaming is performed.
